(19) United States
(12) Patent Application Publication
(10) Pub. No.: US 2003/0028660 A1
(43) Pub. Date: Feb. 6, 2003

(54) Method and system for data distribution

(75) Inventors: Masaru Igawa, Kawasaki (JP); Koichi Shibata, Kamakura (JP)

Correspondence Address: HOGAN & HARTSON L.L.P., 500 S. GRAND AVENUE, SUITE 1900, LOS ANGELES, CA, 90071-2611, US

(73) Assignee: HITACHI, Ltd.

(21) Appl. No.: 10/170,009

(22) Filed: Jun. 11, 2002

(30) Foreign Application Priority Data
Aug. 2, 2001 (JP) 2001-234810

(51) Int. Cl. G06F 15/16

(52) U.S. Cl. 709/231; 709/203

(57) ABSTRACT

A relay apparatus on a network includes an analysis section that analyzes multimedia contents transmitted from a contents provider. The relay apparatus temporarily stores contents identifiers, component information of the contents, and element data pointed by pointers of the component information, and creates a transmission sequence for transmitting the element data. A transmission section transmits the contents identifier, the contents component information and the element data according to the transmission sequence to a service provider. When the relay apparatus receives a request from a terminal or from a service provider even before the service provider completes registration of the entire multimedia contents, the relay apparatus or the service provider can start rendering multimedia transmission services to the terminal.

### BACKGROUND OF THE INVENTION

1. Field of the Invention

The present invention relates to a multimedia content distribution technology for distributing stored multimedia contents to terminals such as audio-visual terminals that are capable of reproducing multimedia contents.

2. Description of Related Art

In the conventional organization or device that transmits multimedia contents (hereinafter referred to as a “service provider”), registration of multimedia data is required before a transmission service is provided.

The registration is composed of operations such as, storing the substance of multimedia contents in a storage device such as a hard disk drive or the like that is controlled by a service provider, and making the service provider to control the information at the storage locations and various kinds of attribute information.

There is the SMIL (Synchronized Multimedia Integration Language) that is prescribed by the World Wide Web Consortium as the standard specification that defines multimedia contents.

When multimedia contents based on the specification are registered to a service provider, the viewer can view and/or listen to the multimedia contents with an apparatus for reproducing the multimedia contents that are created based on the SMIL specification on the other side, the service provider can send the multimedia, contents to the viewer.

In many cases, a service provider is different from a multimedia content creator (hereinafter referred to as a “content provider”). In this case, created multimedia contents are registered through a network at the service provider.

For example, in the case of multimedia contents that are news contents, there are many sites around the world that create and transmit news articles.

News contents distribution services become available only after the contents are once sent to the contracted service providers and registered at the service providers, no matter how far the service providers are located.

However, in the conventional technology, it is possible to view and listen to multimedia contents only after a service provider has finished the registration of the multimedia contents. Some multimedia contents may have a large data size, because it may contain moving picture data and the like. Even when there are demands in starting services to distribute contents such as news contents as soon as they have been created, it may take a long time to transmit multimedia contents created at a content provider to a service provider, if the content provider is located physically far away from the service provider and in particular when the multimedia contents has a large data size. This causes a problem in that the start of the service is delayed.

### SUMMARY OF THE INVENTION

The present invention pertains to solving the problems described above, and enabling to start content distribution services before completely finishing registration of multimedia contents created at a contents provider to a service provider.

An embodiment of the present invention relates to a data distribution method for a data distribution system that temporarily stores data received from outside and transmits the data to another data distribution system.

In one aspect of the present embodiment, the method analyzes multimedia data that is received from outside and temporarily stored, divides the multimedia data into component information of the multimedia data and a plurality of element data, sets a transmission sequence to the multiple element data according to a predetermined rule, transmits the component information of the multimedia data to another data distribution system, and transmits the divided element data to the other data distribution system according to the transmission sequence.

Also, when the data distribution system receives a request for a distribution of multimedia data from outside, if it retains all element data of the multimedia data, all the element data are transmitted to a terminal such as an audio-visual terminal, and, if there is deleted element data that has been sent to another data distribution system among all the element data, the deleted element data is acquired from the other data distribution system, and the acquired element data and element data that are retained without being deleted are transmitted to the terminal.

Also, the present invention relates to a data distribution method for a data distribution system that receives component information of multimedia data and sequentially receives and stores element data of the multimedia data.

When the data distribution system receives a request for distribution of multimedia data from a terminal such as an audio-visual terminal, if all of element data of the multimedia data are stored, all the element data are transmitted to the terminal, and if there is element data that has not been stored, among all the element data of the multimedia data, stored element data are transmitted to the terminal.

Also, the present invention relates to a data distribution system that temporarily stores data received from outside and transmits the data to another data distribution system.

The data distribution system has a device to analyze multimedia data that is received from outside and temporarily stored, a device that divides the multimedia data into component information of the multimedia data and a plurality of element data, a device that sets a transmission sequence to the plurality of element data according to a predetermined rule, a data storage device that stores the component information and the plurality of element data, a data storage device that stores the transmission sequence for the plurality of element data, a device that transmits the component information and the plurality of element data to another data distribution system according to the transmission sequence, and a device that receives a request from a terminal, such as, for example, an audio-visual terminal and transmits the data stored in the data storage device to the terminal.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows a diagram illustrating a structure of a system in accordance with an embodiment of the present invention.

FIG. 2 shows a diagram illustrating a flow of multimedia contents, when a request for viewing and listening reaches a service provider without going through a relay apparatus, in a system in accordance with an embodiment of the present invention.

FIG. 3 shows a diagram illustrating a flow of multimedia contents, when a request for viewing and listening reaches a service provider through a relay apparatus, in a system in accordance with an embodiment of the present invention.

FIG. 4 shows a structure of multimedia contents.

FIG. 5 schematically shows a structure of a relay apparatus.

FIG. 6 shows a structure of a data storage section of the relay apparatus.

FIG. 7 shows a structure of a transmission sequence storage section of a relay apparatus.

FIG. 8 shows a flowchart illustrating a process flow of processes conducted by an analysis section of the relay apparatus.

FIG. 9 shows a flowchart illustrating a process flow of processes conducted by a request handling agent section of the relay apparatus.

FIG. 10 schematically shows a structure of a service provider.

FIG. 11 shows a flowchart illustrating process flow of processed conducted by the request handling agent section.

### PREFERRED EMBODIMENTS OF THE PRESENT INVENTION

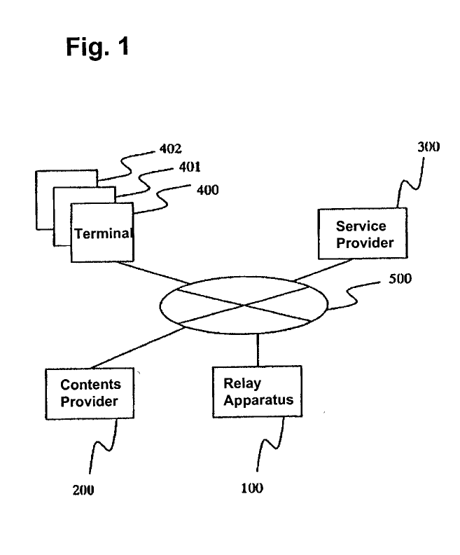

FIG. 1 shows a diagram illustrating a structure of a system that has a network in accordance with an embodiment of the present invention.

The system is essentially composed of a relay apparatus 100, a contents provider 200, a service provider 300, terminals such as audio-visual terminals 400, 401 and 402, and a network 500.

The present invention may be mainly implemented in the relay apparatus 100 and the service provider 300.

When multimedia contents are transmitted from one point to another point on a network such as the Internet, the relay apparatus 100 temporarily retains data and transmits the data to the next point. The purpose to temporarily retain data may vary depending on the situation.

A proxy server to maintain security may be listed as an example of the relay apparatus.

The content provider 200 generally represents organizations and devices that create multimedia contents.

Movie companies, publishing companies and the like may be listed as examples of the organizations.

Real time encoder devices that digitize analog contents may be listed as an example of the devices.

The service provider 300 generally represents organizations and devices that transmit multimedia contents, which are obtained from the content provider 200, to the users who receive the multimedia contents.

Internet service providers that allow the public users to access to the Internet may be listed as an example of the organizations.

Video servers that transmit stored digital moving picture may be listed as an example of the devices.

The terminal 400 is a device that allows the public users to use (for example, view and listen to) multimedia contents that are transmitted from the service provider 300. For example, PCs and set-top boxes and the like may be listed as the terminal 400.

In the network structure, a basic flow of the multimedia contents is as follows.

First, multimedia contents are transmitted from the contents provider 200 to the service provider 300. The service provider 300 stores the multimedia contents.

In many cases, the multimedia contents are transmitted from the content provider 200 to the service provider 300 through the relay apparatus 100.

The relay apparatus 100 stores the multimedia contents in a storage device such as a hard disk, a memory device or the like, and then transmits the multimedia-contents to another relay apparatus or a service provider.

The terminal 400 sends out a request to the service provider 300, which requests the service provider to provide data such as multimedia contents. The request may be a request for providing multimedia contents to view and listen, and may be hereafter simply referred to as a “request”.

The service provider 300 transmits retained multimedia contents to the terminal 400 according to the request.

In the conventional technology, it becomes possible to view multimedia contents on the terminal 400 only after all of the multimedia contents are transmitted from the relay apparatus 100 to the service provider 300.

In contrast, in accordance with the present invention, when it takes a relatively long time to transmit data containing multimedia contents from the relay apparatus 100 to the service provider 300 due to, for example, a relatively low network throughput, the present invention prevents the terminal 400 from waiting for transmission of the multimedia contents.

When it takes a long time to transmit multimedia contents from the relay apparatus 100 to the service provider 300, the multimedia contents are kept stored for a long time on the relay apparatus 100.

In accordance with the present invention, higher priority element data is transmitted first among element data that composes multimedia contents, such as, for example, character data, still picture data, moving picture data, audio data and the like from the relay apparatus 100. The remaining lower priority element data may be transmitted later than the higher priority element data.

When the service provider 300 receives a request for providing multimedia contents from the terminal 400 before completing transmission of the entire data, the service provider 300 transmits element data that has already been retained at the service provider 300 to the terminal 400.

As a result, the terminal can receive higher priority data among the entire multimedia contents, although the terminal initially cannot receive the entire multimedia contents.

For example, when multimedia contents are news contents that may include image data, audio data and character data, even when the image data and audio data cannot be received, the character data can be received.

In this manner, the service provider can start providing services (data) earlier by an amount of time that may be required for transmission of the image data and audio data from the contents provider to the service provider.

Also, in accordance with the embodiment of the present invention, when a request from the terminal 400 to the service provider 300 is sent through the relay apparatus 100, the service provider 300 transmits data that is retained by the relay apparatus 100 to the terminal 400, even when the service provider 300 does not retain the entire data and may require to retrieve more data from the content provider, for example.

In this manner, the service provider can start providing service earlier by an amount of time that may be required for transmission of the remaining data from the contents provider to the service provider.

Moreover, the relay apparatus 100 may delete a part of element data to secure its storage space, for example on a hard disk. Even in this case, when a request is sent from the terminal 400, only the element data that has been transmitted and deleted from the hard disk in the relay apparatus 100 may be acquired again from the service provider, which enables to start providing services. In other words, the hard disk can be efficiently used in the cache function.

It is noted that the relay apparatus 100 may divide and transmit element data of multimedia contents only when the structure of the multimedia contents meets a certain standard.

More specifically, when it does not take a long time to transmit multimedia contents that include for example moving picture data to the service provider 300, the multimedia contents do not need to be divided before transmission. However, when a transmission time exceed a certain threshold value, the multimedia contents may be divided, and character data, for example, among the multimedia contents may be first transmitted and the moving picture data may be later transmitted.

For example, a threshold value related to a difference in the transmission time between element data may be used as a reference.

For example, when multimedia contents are news contents that are composed of character data and moving picture data, the amount of the character data is less than the amount of moving picture data, and in many cases, the character data alone can serve the purpose of news contents.

When character data has A byte, moving picture data has B byte, network throughput with the service provider 300 is C byte per second, and a reference value X establishes the following relation:

(B−A)/C>X,

divided component data may be transmitted. If not, data is normally transmitted without being divided.

By establishing a certain standard like this, transmission of multimedia contents from the relay apparatus 100 to the service provider 300 may be transmitted in a conventional way, when there is little advantage of dividing and transmitting multimedia content.

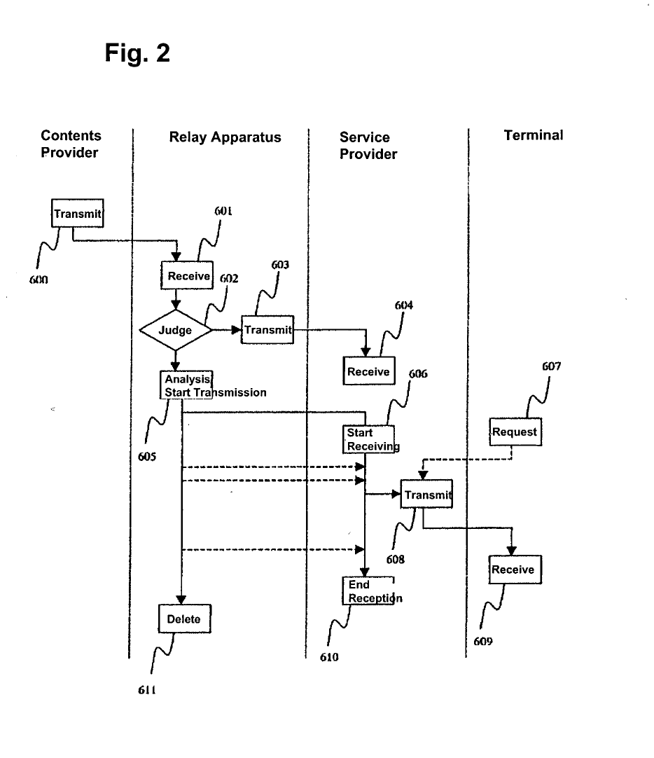

FIG. 2 shows a diagram illustrating a flow of multimedia contents, when a request for viewing and listening reaches a service provider without going through a relay apparatus 100, in a network environment set up in accordance with the present invention.

First, a content provider transmits created multimedia contents to the relay apparatus 100 (step 600).

The relay apparatus 100 receives the multimedia contents (step 601).

Next, a determination is made as to whether the multimedia contents should be divided into element data and transmitted to the service provider 300 or should be transmitted without being divided into element data (step 602).

The judging method to be employed may be the method using a certain threshold value according to transmission time for element data, as described above.

As a result, when it is judged that multimedia contents may be transmitted without dividing, the process proceeds to a step indicated by a right arrow, and all of the multimedia contents are transmitted to the service provider 300 (step 603). In this case, the transmission process is conducted in the same manner as the conventional process.

The service provider 300 receives the multimedia contents (step 604).

On the other hand, when it is judged that multimedia contents from the content provider may be divided into element data and then transmitted, the relay apparatus 100 analyzes multimedia data and divides the same into plural element data, determines a sequence in transmitting the element data and starts transmission of the element data thus divided to the service provider (step 605).

The service provider starts successively receiving and accumulating the divided data successively sent from the relay apparatus 100 (step 606).

Meanwhile, let us assume that the terminal 400 sends a request for obtaining multimedia contents (step 607), and the request reaches the service provider 300.

The service provider 300 starts transmitting only the data among multimedia contents that is retained at the service provider 300 to the terminal 400 (step 608).

The terminal 400 receives the data transmitted from the service provider 300, and the data may be viewed and listened to (step 609).

In the meantime, the service provider 300 completes receiving the entire element data that is transmitted from the relay apparatus 100 (step 610).

At the relay apparatus 100, even after completing transmission of the entire multimedia contents to the service provider 300, the multimedia contents may be retained for a while as cache data. However, when certain conditions are met, such as, for example, when a free hard disk space become less than a predetermined amount, all of the retained multimedia contents may be deleted (step 611).

By the flow described above, when a request for viewing and listening from the terminal 400 reaches the service provider 300 without going through the relay apparatus 100, the service provider 300 can transmit multimedia contents to the terminal 400 before completing registration of the multimedia contents.

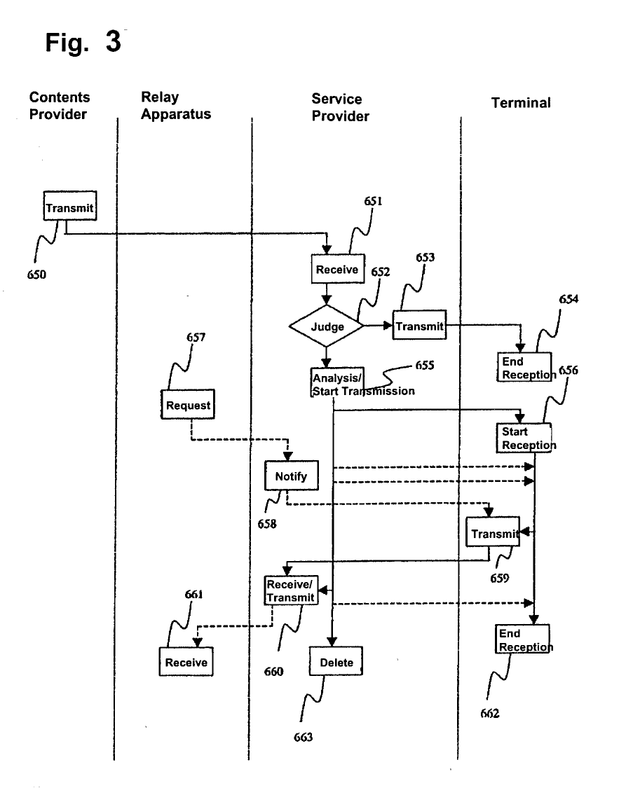

FIG. 3 shows a diagram illustrating a flow of multimedia contents, when a request for viewing and listening goes through the relay apparatus 100, in a network environment in accordance with the embodiment of the present invention.

First, the contents provider 200 transmits multimedia contents to the relay apparatus 100 (step 650).

The relay apparatus 100 receives the multimedia contents (step 651).

Next, a judgment is made as to whether the multimedia contents should be divided into plural element data and transmitted to the service provider 300 or should be transmitted without being divided into multiple element data (step 652).

The judging method to be employed may be the method using a certain threshold value according to transmission time for element data, as described above.

As a result, when it is judged that multimedia contents may be transmitted without being divided, the process proceeds to a step indicated by a right arrow, and the entire multimedia contents are transmitted to the service provider 300 (step 653). This process is equivalent to the conventional method.

The service provider 300 receives the multimedia contents (step 654).

On the other hand, when it is judged that multimedia contents may be transmitted after divided into multiple element data, the relay apparatus 100 analyzes multimedia contents and divides the same into multiple element data, determines a sequence in transmitting the element data, and starts transmission of the element data to the service provider (step 656).

The service provider starts successively receiving and accumulating the divided data successively sent from the relay apparatus 100 (step 656).

Meanwhile, let us assume that the terminal 400 sends a request for viewing and listening to multimedia contents (step 657), and the request reaches the relay apparatus 100.

When the relay apparatus 100 retains multimedia contents that are requested by the terminal 400, the relay apparatus 100 transmits the multimedia contents to the terminal 400. However, when some element data among the multimedia contents, which is requested by the terminal 400, has already been deleted after being transmitted to the service provider, the relay apparatus 100 informs the detail to the service provider 300 (step 658).

The service provider 300 receives the detail and transmits the corresponding element data among the multimedia contents to the relay apparatus 100 (step 659).

The relay apparatus 100 receives the element data and composes the multimedia contents that are requested by the terminal 400 with the data that is retained by the relay apparatus 100, and transmits the multimedia contents to the terminal 400 (step 660).

The terminal 400 receives the multimedia contents (step 661).

Meanwhile, the service provider 300 completes receiving all of the multimedia contents that have been divided into element data and transmitted from the relay apparatus 100 (step 662).

The relay apparatus 100, even after completing transmission of the entire multimedia contents to the service provider 300, continues retaining multimedia data as cache data for a while. However, when certain conditions are met, for example when a free hard disk space becomes less than a predetermined amount, the relay apparatus 100 may delete all of the retained multimedia contents.

By the flow described above, when a request from the terminal 400 reaches the service provider 300 through the relay apparatus 100, the service provider 300 can start transmitting multimedia contents to the terminal while using the multimedia contents retained at the relay apparatus as cache data before completing registration of the multimedia contents.

Structures of multimedia contents, the relay apparatus 100, the contents provider 200, and the service provider 300 are described below in greater detail.

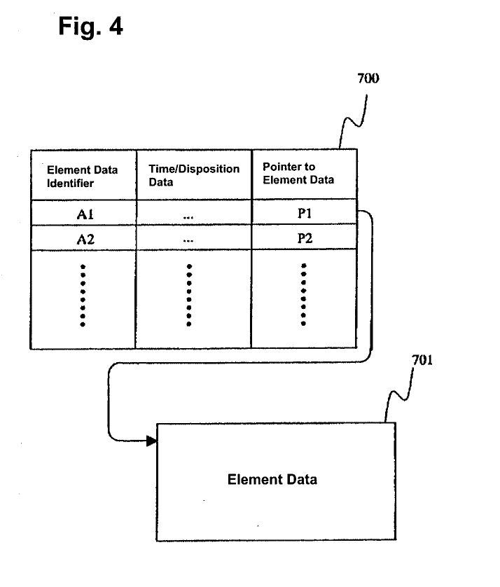

FIG. 4 shows a typical structure of the multimedia contents.

Multimedia contents are mainly composed of component information 700 and element data 701.

Element data 701 composes substances of the multimedia contents. For example, the element data 701 may include, for example, character data, still image data, audio data and moving picture data.

The component information 700 stores element data identifier and time/disposition information for each of the element data, and pointer to each of the element data, which are associated with each of the element data.

Time/disposition information represents how individual element data is combined in time and space.

For example, in the case of multimedia contents for 60 seconds, the multimedia contents may retain information that is equivalent to a content indicating that a still picture 1 has a size of 100×100 in a rectangular shape, and display of the still picture 1 starts ten seconds from the beginning and ends 20 second from the beginning.

There are some standard specifications to express these multimedia contents. For example, one of them is SMIL (Synchronized Multimedia Integration Language) that is prescribed by the World Wide Web Consortium.

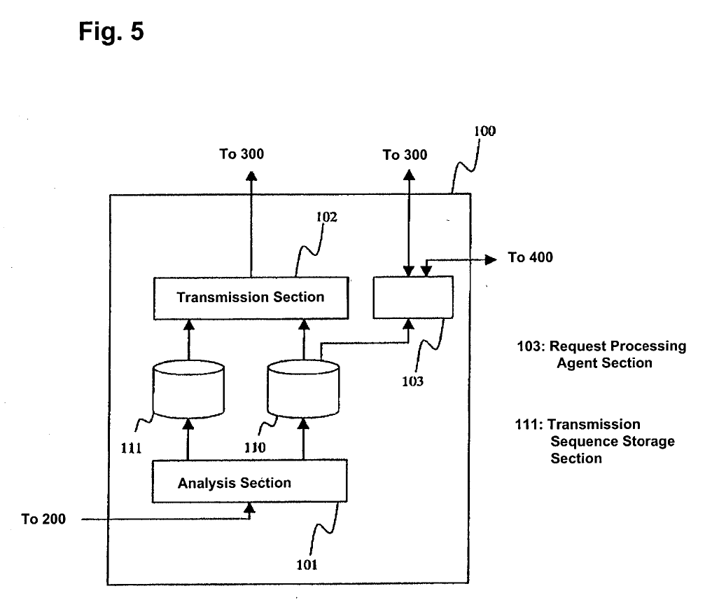

FIG. 5 schematically shows a diagram illustrating a structure of the relay apparatus 100 in a network environment that of the present embodiment.

The relay apparatus 100 is composed of an analysis section 101, a transmission section 102, a request handling agent section 103, a data storage section 110 and a transmission sequence storage section 111.

The analysis section 101 has a function to receive multimedia contents from the contents provider 200 and analyze the multimedia contents.

The analyzed multimedia contents are divided into component information and element data and stored in the storage section.

Also, the analysis section 101 has a function to judge whether or not element data should be divided by referring the element data with a predetermined standard, before they are transferred to the service provider 300.

The standard of judgment may be, for example, a specific threshold value related to transmission times for specified element data.

Assuming that multimedia contents are news contents that are composed of at least character data and moving picture data, in this example, the amount of the character data is relatively less than the amount of the moving picture data. Also, in many cases, the character data alone can serve the purpose of the news contents.

The multimedia contents may be transmitted without being divided if it is determined that it does not take a long time to transmit the moving picture data to the service provider 300. On the other hand, however, the analysis section 101 makes a judgment that the multimedia contents may be divided, the character data may be transmitted first, and the moving picture data later, if the transmission time exceeds a predetermined threshold value,

The analysis section 101, when it divides data to individual element data and transmits the same to the service provider 300, has a function to decide the sequence in transmitting the divided individual element data.

For example, the priority of element data may be used as a standard for determining the sequence,

For example, when contents are news contents, in many cases, character data itself can serve the purpose of news contents as described above.

Character data can be considered as high priority data in news contents.

Since priority can be explicitly described depending on multimedia contents, when there is a description for the priority, the sequence is determined according to the description. When there is no description for the priority, a predetermined sequence that is determined according to types of element data is applied.

Another standard for determining the sequence, for example, is the amount of data.

Small amount of element data can be transmitted to the service provider 300 in a short period of time.

When only one set of element data has been transmitted, such element data can be served to the terminal 400 as multimedia contents.

Therefore, in one of the methods for transmitting the data, smaller amount of data may be transmitted first.

The analysis section 101 determines a transmission sequence in this manner, and then, stores the results in the transmission sequence storage section 111.

The transmission section 102 has a function to transmit component information and element data, which are stored in the data storage section 110.

A transmission sequence is retrieved from the transmission sequence storage section 111.

When transmission of data has been completed, the transmission section 102 stores a record indicating that the transmission has been completed in the transmission sequence storage section 111.

According to certain conditions, such as free space on the hard disk or the like, the transmission section 102 deletes element data that has already been completely transmitted among the element data in the data storage section 110.

When element data is deleted, the transmission section 102 stores in the transmission sequence storage section 111 a record indicating that the element data is deleted.

The request handling agent section 103 has a function to receive and handle requests for viewing and listening transmitted from the terminal 400.

The request handling agent section 103 checks according to multimedia contents identifiers that are obtained from the terminal 400 whether or not the data storage section 110 contains element data that compose the requested multimedia contents.

When element data has already been deleted, the request handling agent section 103 creates a list of the deleted element data, transmits the list to the service provider 300 and requests the service provider 300 to provide the element data that has been deleted.

When the element data is transmitted from the service provider 300, the element data is transmitted to the terminal 400 together with the element data that remains on the data storage section 110.

If the contents provider 200 has made a registration to the service provider 300 through the relay apparatus 100, it can be said that registered multimedia contents exist ether on the relay apparatus 100 or the service provider 300.

Consequently, it can be said that any element data that is not retained by the relay apparatus 100 is always transmitted from the service provider 300.

A description will be made below as to how a fee collection system that is required in many contents providing systems is used.

Generally, when contents stored in a service provider are served to a terminal, the amount of contents transmitted to the terminal is measured and a fee for the contents transmitted is charged to the terminal according to the amount of the contents.

Such fee collection system can be used in the environments in which the present invention is applied.

When the request handling agent section 103 receives a request for viewing and listening from the terminal 400, if all of the multimedia contents can be transmitted to the terminal 400, a fee for the amount of contents can be charged without any problem.

Even when a part of element data is missing, the missing element data can be transmitted from the service provider 300, and all of the element data can be finally transmitted to the terminal 400. Accordingly, a fee for the entire amount of the contents can be charged in the same manner.

In either of the cases, the request handling agent section 103 can charge fees for viewing and listening to the contents to the terminal 400 as an agent for the service provider 300.

The functions of the analysis section 101, the transmission section 102 and the request handling agent section 103 enable the relay apparatus 100 to temporarily store multimedia contents that are transmitted from the contents provider 200 and transmit element data in the multimedia contents to the service provider 300 in a sequence based on a predetermined standard.

When the relay apparatus 100 receives a request from the terminal 400 during transmission, the relay apparatus 100 can transmit requested multimedia contents in place of the service provider 300 to the terminal 400.

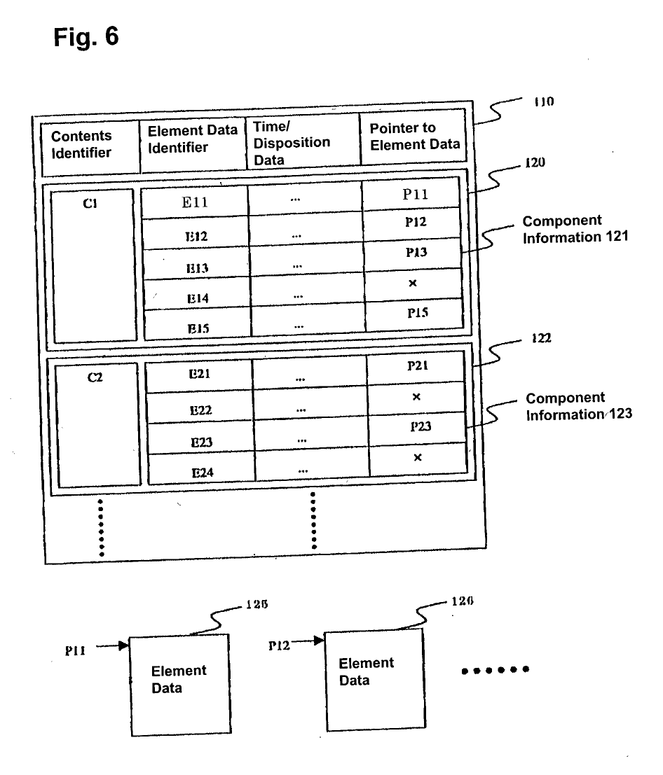

FIG. 6 is a diagrams generally illustrating a structure of the data storage section 110. The data storage section 110 is mainly composed of sections 120 and 122 that store contents identifiers and component information that are associated with one another, and element data 125, 126. It is noted that FIG. 6 shows only a part of the sections that store contents identifiers and component information, and a part of the element data, and the data storage section 110 may contain more than two of these sections and more than two of the element data.

The contents identifiers are identifiers to distinguish contents.

The component information stores element data identifiers, time/location information, and pointers to element data associated with one another, in a manner similar to the example described above with reference to FIG. 4.

It is noted that a format for storing these component information and element data does not depend on the SMIL specification.

Each of the element data can be stored as one file in a storage section such as a hard disk. In this case, the pointer to the element data in the component information 121 can use a file name of that file.

The element data (125, for example) may be deleted by the transmission section 102. In this case, a record is made that the element data has already been deleted at the pointer to the deleted element data in the component information 121.

In this figure, sections with marks “x” indicate that element data have already been deleted. In practice, null characters may be used instead for the “x” marks.

The data storage section 110 with the structure described above enables the transmission section 102 to retrieve element data that are to be transmitted to the service provider 300.

Also, with the structure described above, the request handling agent section 103 can efficiently make a list of element data that do not exist in the data storage section 110.

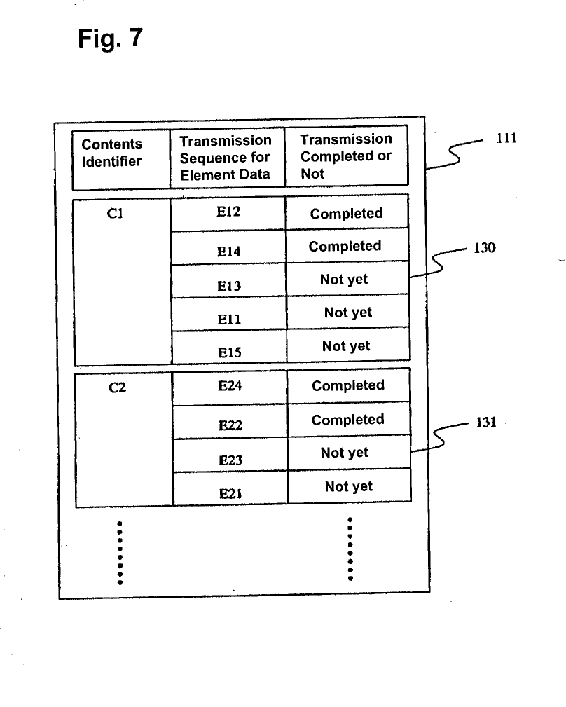

FIG. 7 is a diagram generally illustrating a structure of the transmission sequence storage section 111. FIG. 7 shows only a part of the structure of the transmission sequence storage section 111.

The transmission sequence storage section 111 retains a transmission sequence of element data and information as to whether or not element data has been transmitted with each of the multimedia contents.

Each of the information (130, 131, etc.) corresponds to each of the multimedia contents.

The information for each set of multimedia contents stores, for example, a contents identifier and a transmission sequence of element data associated with that set of multimedia contents specified by the identifier.

In addition, each of the element data includes a record indicating whether or not transmission of the same to the service provider 300 has been completed.

Information of the transmission sequence storage section 111 allows the transmission section 102 to know a sequence of transmission of element data to be transmitted to the service provider 300.

The records indicating whether or not transmission of any of the element data has been completed are renewed every time the transmission section 102 transmits these element data.

This information allows the analysis section 101 to select data that can be deleted, when the analysis section 101 deletes element data to prevent the hard disk space from becoming full.

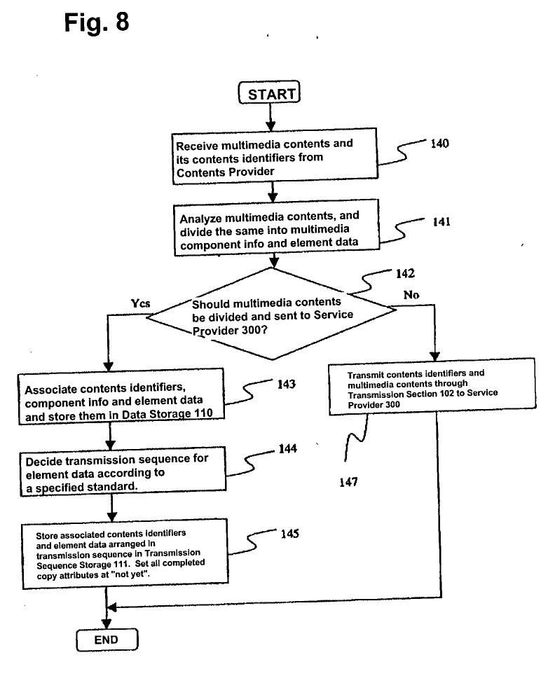

FIG. 8 shows a process flow chart at the analysis section 101.

The process of the analysis section 101 is described hereunder with reference to the flow chart of FIG. 8.

First, the analysis section 101 receives multimedia contents and identifiers that identify the multimedia contents from contents provider (step 140).

Next, the analysis section 101 analyses the multimedia contents and divides the same into component information and element data (step 141).

The analysis section 101 judges, according to a judgment standard, whether or not the multimedia contents should be divided and the divided elements should be transmitted independently to the service provider 300, or the multimedia contents should be transmitted without being divided into element data in the conventional manner (step 142).

When it is judged that the multimedia contents should be divided and transmitted, the contents identifiers, component information and element data are associated with one another and stored in the data storage section 110 (step 143).

The analysis section 101 determines a transmission sequence according to the predetermined standard described above (step 144).

The contents identifiers and the transmission sequence information about the element data are associated with one another and stored in the transmission sequence storage section 111.

Attribute indicating that copying has been completed is first set to “not yet” as an initial value (step 145).

On the other hand, in step 142, when it is judged that the multimedia contents should be transmitted without being divided, the contents identifiers and multimedia contents are transmitted to the service provider 300 through the transmission section 102.

The process flow at the analysis section 101 is described above.

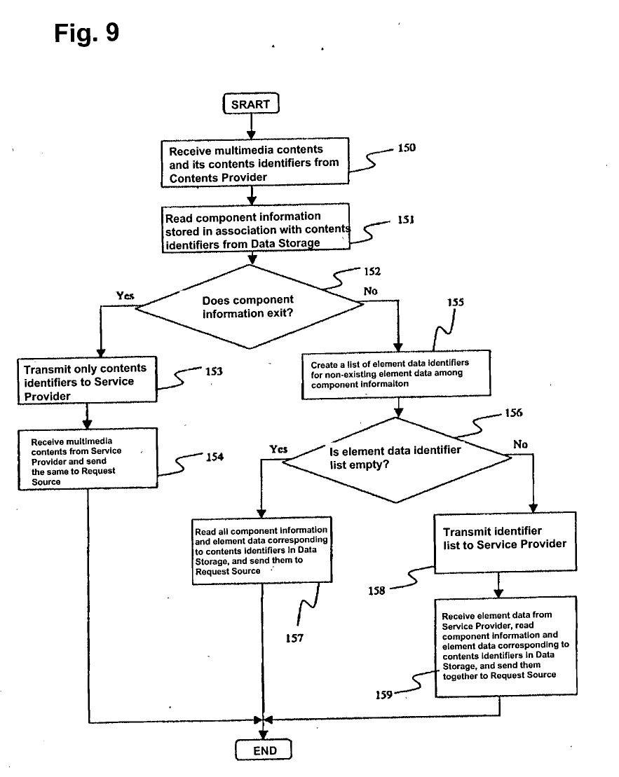

FIG. 9 shows a diagram illustrating a process flow at the request handling agent section 103.

A process of the request handling agent section 103 is described hereunder according to the flowchart of FIG. 9.

First, the request handling agent section 103 receives contents identifiers of multimedia contents that are requested for viewing and listening from a request source such as the terminal 400 (step 150).

Next, the request handling agent section 103 tries to retrieve component information that is associated with the contents identifiers described above and stored from the data storage section 110 (step 151).

When component information does not exist (step 152), since this means that transmission of the multimedia contents to the service provider 300 has been completed, only the contents identifiers are transmitted to the service provider 300 (step 153).

Upon receiving the multimedia contents from the service provider 300, the request handling agent section 103 transmitted the same to the request source (step 154).

The above is equivalent to the process done by the conventional relay apparatus.

On the other hand, in step 152, when component information exists in the data storage section 110, the process proceeds as follows.

The request handling agent section 103 picks up identifiers of element data that do not exist and makes a list of such element data identifiers (step 155).

When this list of element data identifiers is empty, in other words, all of the element data exists in the data storage section 110 (step 156), the request handling agent section 103 retrieves from the data storage section 110 all of the component information and element data corresponding to the contents identifiers that are designated by the request source, and transmits the same to the request source (step 157).

On the other hand, when the list of element data identifiers is not empty, in other words, when there are already element data that do not exist in the component information, the process proceeds as follows.

The request handling agent section 103 transmits a list of the identifiers of element data that do not exist to the service provider 300.

The request handling agent section 103 receives the element data from the service provider 300, retrieves all of the component information and existing element data from the data storage section 110, and transmits these together to the request source.

The process flow at the request handling agent section 103 is described above.

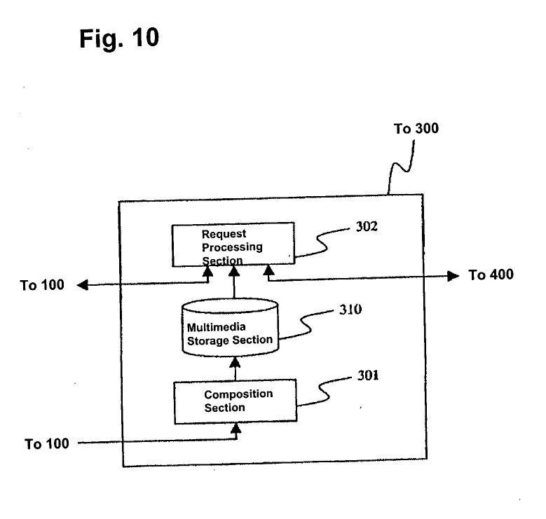

FIG. 10 schematically shows a structure of the service provider 300.

The service provider 300 is composed of at least a composition section 301, a request processing section 302 and a multimedia storage section 310.

The composition section 301 composes multimedia contents from contents identifiers, component information and element data that are transmitted from the relay apparatus 100, and stores them in the multimedia storage section 310.

However, since sets of element data arrive individually, the composition section 301 performs the composition operation every time the individual element data arrives.

Until all of the element data arrive, multimedia contents that lack a part of data are stored in the multimedia storage section 310.

The request processing section 302 has a function to receive a request for transmission of multimedia contents from the terminal 400 or from the relay apparatus 100, and transmit multimedia contents according to the request.

The request processing section 302 receives contents identifiers from the terminal 400 when a request for viewing and listening is made.

The request processing section 302 retrieves multimedia contents corresponding to the contents identifiers from the multimedia storage section 310 and transmits the same to the terminal 400.

In this case, if multimedia contents are stored as a complete form, the same function as that of the conventional multimedia server is performed.

However, the multimedia storage section 310 may lack a part of element data.

In this case, only the data existing on the multimedia storage section 310 are transmitted to the terminal 400.

This is effective, for example, when character data has been stored but moving picture data has not been stored yet. This is because, in many news contents, character data alone may be valuable as the news information.

When the request processing section 302 receives a request for transmission of element data from the relay apparatus 100, the request processing section 302 retrieves the element data from the multimedia storage section 310 and transmits the same to the relay apparatus 100.

The multimedia storage section 310 associates and stores the contents identifier, component information and element data of multimedia contents.

The multimedia storage section 310 therefore has the structure similar to that of the data storage section 110 shown in FIG. 6.

However, the multimedia storage section 310 differs from the data storage section 110 in that, in the multimedia storage section 310, all of pointers to real data do not exist when only contents identifiers and component information are initially stored. In other words, since the pointers stored in component information at the relay apparatus are the pointers at the relay apparatus, such pointers are not transmitted to the service provider 300.

Since element data are transmitted from the relay apparatus 100 after contents identifiers and component information, and stored in the multimedia storage section 310, every time element data is transmitted and stored in the multimedia storage section 310, a pointer to the stored element data is recorded.

Data in the multimedia storage section 310, when all of element data for each multimedia contents are acquired, do not need to be retained in the structure described above, and may be reformatted in a format according to a specified standard such as the SMIL.

In this case, when the request processing section 302 retrieves element data, an analyzing process is needed.

With the structure described above, the service provider 300 can accommodate both of the cases in which a request for viewing and listening from the terminal 400 is transmitted through the relay apparatus and is not transmitted through the relay apparatus.

The following is a description of how a fee collecting system that may be required in many contents providing systems is used.

Generally, when contents stored at a service provider are served to a terminal, the amount of contents transmitted to the terminal is measured and a fee for the contents transmitted is charged to the terminal according to the amount of the contents.

Such fee collection system can be used in the environments in which the present invention is applied.

When the request handling agent section 303 receives a request for viewing and listening from the terminal 400, if all of the multimedia contents could be transmitted to the terminal 400, a fee for the amount of contents can be charged without any problem.

When a part of the requested element data is missing, the condition of existence of element data in the multimedia storage section 310 is checked, which makes it possible to know the content of the multimedia contents that could be served to the terminal 400. Therefore, a fee may be charged according to the content.

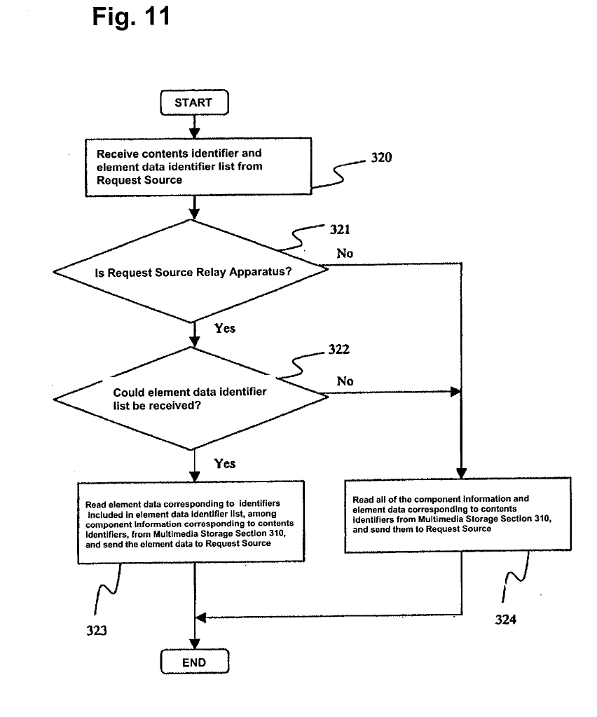

FIG. 11 shows a process flow at the request processing section 302.

A process of the request processing section 302 is described hereunder with reference to the flowchart.

The request processing section 302 tries to receive contents identifiers and a list of element data identifiers from a request source such as the terminal 400 or the relay apparatus 100 (step 320).

When the request source is the relay apparatus 100 (step 321) and a list of element data identifiers can be received (step 322), since the relay apparatus 100 requests element data that the relay apparatus 100 does not have, the following process is conducted.

The relay apparatus 100 retrieves from the multimedia storage section 310 element data corresponding to identifiers that are included in the received list of element data identifiers among the component information corresponding to the received contents identifiers, and transmits the retrieved element data to the request source (step 323).

On the other hand, when the request source is the relay apparatus 100 (step 321), and a list of element data identifiers is not received (step 322), or the request source is the terminal (step 321), the request processing section 302 retrieves component information and all of the element data corresponding to the received contents identifiers from the multimedia storage section 310, and transmits these component information and element data to the request source.

As described above, in the embodiments of the present invention, when a request for viewing and listening from the terminal 400 it transferred through the relay apparatus 100, multimedia contents stored in the relay apparatus 100 can be transmitted to the terminal 400. When a request for viewing and listening from the terminal 400 is not transferred through the relay apparatus 100, a part of the requested multimedia contents that is retained by the service provider 300 and has a relatively higher priority can be transmitted.

In addition, the present invention is applicable to an embodiment in which the relay apparatus 100 is included in the contents provider 200.

Also, the present invention is operable in a situation where the relay apparatuses 100 are constructed with multiple stages between the contents provider 200 and the service provider 300.

Assuming that there is another relay apparatus 190 between the contents provider 200 and the service provider 300, the contents of the process performed at the relay apparatus 100 for the service provider 300 as described above may be replaced with contents of a process to be carried out at the relay apparatus 100 for the relay apparatus 190.

As described above, the present invention makes it possible to start providing services when a terminal such as a multimedia-capable terminal makes a request for viewing and listening even before a contents provider completes registration of multimedia contents to a service provider.

In particular, when there is a request for viewing and listening that is sent directly from a terminal to a service provider, the service provider may transmit a part of element data retained among the requested multimedia contents. This allows the service to be rendered even before completing registration.

Also, when there is a request for viewing and listening that is sent through a relay apparatus, the relay apparatus may transmit multimedia contents retained at the relay apparatus. This allows the service to be rendered to a terminal even before completing registration to a service provider.

Also, in the case described above, even when the relay apparatus deletes a part of element data that has been transmitted to a service provider in order to free a hard disk space, it is possible to provide service to a terminal by acquiring element data again from a service provider.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A data distribution method for a data distribution system that temporarily stores data received from outside and transmits the data to another data distribution system, the method comprising:
analyzing the data that is received from outside and temporarily stored;
dividing the data into component information and a plurality of element data;
setting a transmission sequence to the plurality of element data according to a specified rule; and
transmitting the component information to the other data distribution system, and transmitting the divided element data to the other data distribution system according to the transmission sequence.

2. A data distribution method according to claim 1, wherein the element data includes at least character data and image data, and the data is divided when a rate of the image data to the character data exceeds a predetermined value.

3. A data distribution method according to claim 1, wherein the element data includes a plurality of element data, and the transmission sequence is set according to predetermined priorities given to the element data.

4. A data distribution method according to claim 1, wherein, upon receiving a request for transmission of multimedia data from a terminal, when any element data among the element data retained at the data distribution system has been sent to the other data distribution system and deleted, the deleted element data is acquired from the other data distribution system, and the acquired element data and the element data that is retained without being deleted are transmitted to the terminal.

5. A data distribution method according to claim 1, wherein, upon receiving a request for transmission of multimedia data from a terminal, when the data distribution system retains all element data of the multimedia data, all the element data are transmitted to the terminal.

6. A data distribution method according to claim 1, wherein, upon receiving a request for transmission of multimedia data from a terminal, when the data distribution system retains all element data of the multimedia data, all the element data are transmitted to the terminal, and when any element data among the element data retained at the data distribution system has been sent to the other data distribution system and deleted, the deleted element data is acquired from the other data distribution system, and the acquired element data and the element data that is retained without being deleted are transmitted to the terminal.

7. A data distribution method for a data distribution system that receives multimedia data, the method comprising:
receiving component information of the multimedia data;
sequentially receiving element data of the multimedia data;
receiving a request for distribution of the multimedia data from a terminal; and
when any element data among all of the element data of the multimedia data is not stored, transmitting already stored element data among the all of the element data to the terminal.

8. A data distribution method according to claim 5, further comprising transmitting all of the element data to the terminal when all of the element data of the multimedia data are stored.

9. A data distribution system that temporarily stores data received from outside and transmits the data to another data distribution system, the data distribution system comprising:
a device that analyzes the data that is received from outside and temporarily stored;
a device that divides the multimedia data into component information and a plurality of element data;
a device that sets a transmission sequence to the plurality of element data according to a predetermined rule; and
a device that transmits the component information to the other data distribution system, and transmits the plurality of element data to the other data distribution system according to the transmission sequence.

10. A data distribution system according to claim 9, wherein the plurality of element data include at least character data and image data, and the data is divided when a rate of the image data to the character data exceeds a predetermined value.

11. A data distribution system according to claim 9, wherein the transmission sequence is set according to predetermined priorities given to the plurality of element data.

12. A data distribution system according to claim 9 further comprising:
a data storage device that stores the component information and the plurality of element data;
a data storage device that stores the transmission sequence for the plurality of element data; and
a device that receives a request from a terminal and transmits the component information and the plurality of element data stored in the data storage device to the terminal.

13. A computer readable recording media storing a program that enables a computer to perform at least the functions of:
analyzing multimedia data that is received from outside and temporarily stored;
dividing the multimedia data into component information and a plurality of element data; and
determining a transmission sequence to send out the plurality of element data according to a predetermined rule.

14. A computer readable recording media storing a program according to claim 13, wherein the plurality of element data include at least character data and image data, and the multimedia data is divided when a rate of the image data to the character data exceeds a predetermined value.

15. A computer readable recording media storing a program according to claim 13, wherein the transmission sequence is set according to predetermined priorities given to the plurality of element data.

16. A computer readable recording media storing a program according to claim 13, wherein the functions further comprise:
associating identifiers, the component information and the plurality of element data of the multimedia data;
storing the identifiers, the component information and the plurality of element data of the multimedia data;
associating the identifiers of the multimedia data and the plurality of element data arranged according to the transmission sequence;
adding flags indicating whether or not the corresponding element data have been transmitted; and
setting all of the flags at a value indicating that the corresponding element data have not yet been transmitted and storing the flags in a storage device.

17. A program that enables a computer to perform at least the functions of:
analyzing multimedia data that is received from outside and temporarily stored;
dividing the multimedia data into component information and a plurality of element data; and
determining a transmission sequence to send out the plurality of element data according to a predetermined rule.

18. A program according to claim 17, wherein the plurality of element data include at least character data and image data, and the multimedia data is divided when a rate of the image data to the character data exceeds a predetermined value.

19. A program according to claim 17, wherein the transmission sequence is set according to predetermined priorities given to the plurality of element data.

20. A program according to claim 17, wherein the functions further comprise:
associating identifiers, the component information and the plurality of element data of the multimedia data;
storing the identifiers, the component information and the plurality of element data of the multimedia data;
associating the identifiers of the multimedia data and the plurality of element data arranged according to the transmission sequence; and
setting all of the flags at a value indicating that the corresponding element data have not yet been transmitted and storing the flags in a storage device.
